(19) United States
(12) Patent Application Publication
(10) Pub. No.: US 2024/0270764 A1
(43) Pub. Date: Aug. 15, 2024

(54) METHOD FOR PURIFYING TIN COMPOUNDS

(71) Applicants: Mitsubishi Chemical Corporation, Tokyo (JP); GELEST, Inc., Morrisville, PA (US)

(72) Inventor: Hiroshi FUKUI, Tokyo (JP)

(73) Assignees: Mitsubishi Chemical Corporation, Tokyo (JP); GELEST, Inc., Morrisville, PA (US)

(21) Appl. No.: 18/532,544

(22) Filed: Dec. 7, 2023

Related U.S. Application Data
(60) Provisional application No. 63/445,119, filed on Feb. 13, 2023.

(51) Int. Cl. C07F 7/22

(52) U.S. Cl. CPC C07F 7/2296

(57) ABSTRACT

A method for purifying a tin compound, including: making an inert gas pass through in, or on a surface of, a liquid containing a tin compound represented by a chemical formula RSnX₃, where R represents a hydrocarbon group having 1 to 30 carbon atoms optionally substituted with a halogen atom, and X represents a hydrolysable substituent, to perform stripping, before or after a distillation step of the tin compound.

### CROSS REFERENCE TO RELATED APPLICATIONS

The present application claims the benefits of priority to U.S. provisional application No. 63/445,119, filed on Feb. 13, 2023, the entire disclosure of which is incorporated herein by reference.

### TECHNICAL FIELD

The present disclosure relates to a method for purifying tin compounds requiring high purity, for use in photolithography of semiconductor manufacturing processes, and the like. More particularly, the present disclosure relates to a method for purifying a crude tin compound by removing volatile impurities such as halogen, hydrogen halide, oxygen, and organic solvent that are contained in the crude tin compounds.

### BACKGROUND ART

In recent years, there has been a need to handle a greater amount of information at higher speeds with higher precision against the backdrop of a paradigm shift to an advanced information society, and technologies related to semiconductor devices such as integrated circuits using semiconductors have been advancing noticeably day by day.

A semiconductor device is manufactured by a multi-step process including photolithography. Typically, this process includes patterning of materials by lithography technology. Typical photolithography process steps well known in the art include preparation of a substrate, application of photoresist by, e.g., spin coating, exposure of the photoresist with desired pattern, some dissolution of the exposed region of the photoresist by a developer, development by application of a developer for removing the exposed or unexposed region of the photoresist, and a subsequent process for forming features on a substrate region in which the photoresist has been removed by etching, material deposition, or the like.

Evolution of semiconductor design requires formation of features that are finer than ever before on a semiconductor substrate material. Each feature is approximately not greater than 22 nanometers (nm), and possibly less than 10 nm in some cases. One challenge in production of a device with such fine features is ability to form a photolithography mask having sufficient resolution, securely and reproducibly. To achieve a feature size of smaller than wavelength of light, it is necessary to use complicated resolution improvement technology such as multiple patterning. Therefore, development of photolithography technology using shorter wavelength light such as extreme ultraviolet radiation (EUV) having a wavelength of 10 nm to 15 nm (for example, 13.5 nm) is important.

A conventional organic chemically amplified resist (CAR) has a low adsorption coefficient especially in EUV region, and thus has a potential drawback when used in EUV lithography, because there is possibility that diffusion blur of photoactivated chemical species or line edge roughness occur. Therefore, there remains a necessity for an improved EUV photoresist material having properties such as thin thickness, more excellent absorbance, and more excellent etching resistance.

Therefore, a liquid CVD material such as organic tin has come into use as a resist applied particularly for EUV, in recent years. For improving quality of film formation, an extremely high purity material is in need. Accordingly, in tin compounds, which are preferably used among organic tin, impurities such as water, a residual solvent used in synthesis, and metal impurities are removed by distillation or the like, before it is used as the CVD material (Patent Literature 1).

### RELATED ART DOCUMENT

### Patent Document

PTL 1: JP-A-2020-530199

### SUMMARY

### Problems to be Solved by the Disclosure

In conventional methods, however, when liquid tin compounds are distilled to high purity and used as the CVD material, generation of a defect such as a decrease of a void as compared to a case in which a gaseous material is used, quality improvement of an ultrathin film with a thickness level of approximately 10 nm cannot be sufficiently attained. The reason why a high-quality thin film cannot be obtained is estimated as follows. The presence of volatile impurities such as halogen, hydrogen halide, oxygen, and organic solvent in a liquid of tin compound causes decomposition or alteration of the tin compound by heating during vaporization. Such decomposition or alteration may adversely affect the vapor phase growth. No clear solution for such problem has been reported yet.

Thus, under such circumstance, the present disclosure has for its object to provide a method for purifying a tin compound capable of achieving quality improvement of a thin film.

### Means for Solving the Problems

As a result of intensive investigations to solve these problems, the present inventor found that volatile impurities such as halogen, hydrogen halide, oxygen, and organic solvent dissolved in a liquid of tin compound cannot be sufficiently removed even by distillation, and by making an inert gas pass through in, or on a surface of, a liquid containing a tin compound, and further applying ultrasonic vibration in a case where fine bubbles are not sufficiently generated, a trace amount of volatile impurities dissolved in the liquid can be removed almost completely. Thereby, the present disclosure was accomplished.

That is, the present disclosure has the following aspects.

[I] A method for purifying a tin compound, including: making an inert gas pass through in, or on a surface of, a liquid containing a tin compound represented by a chemical formula RSnX₃, where R represents a hydrocarbon group having 1 to 30 carbon atoms optionally substituted with a halogen atom, and X represents a hydrolysable substituent, to perform stripping, before or after a distillation step of the tin compound.

[II] The method for purifying a tin compound as recited in [I], wherein the stripping is performed by applying ultrasonic vibration.

[III] The method for purifying a tin compound as recited in [I] or [II], wherein the inert gas is made to pass through such that the tin compound is stirred by a fine bubble of the inert gas.

[IV] The method for purifying a tin compound as recited in any one of [I] to [III], wherein an amount of the inert gas passing per unit volume with respect to a liquid surface of a container, in which the liquid containing the tin compound is stored, is 0.1 to 4.0 m³ (gas)/s·m³ (liquid).

[V] The method for purifying a tin compound as recited in any one of [II] to [IV], wherein a frequency of the ultrasonic is 40 kHz to 3 M Hz, and an ultrasonic output is 0.1 to 240 W per 1 L of the tin compound.

[VI] The method for purifying a tin compound as recited in any one of [I] to [V], wherein, in the tin compound represented by the chemical formula RSnX₃, R represents an alkyl group having 1 to 10 carbon atoms, an alkenyl group having 1 to 10 carbon atoms, an alkynyl group having 1 to 10 carbon atoms, or an alkyl group having 1 to 10 carbon atoms substituted with a halogen atom, and X represents a dialkylamino group having 1 to 10 carbon atoms or an alkoxy group having 1 to 10 carbon atoms.

[VII] The method for purifying a tin compound as recited in any one of [I] to [VI], wherein the tin compound represented by the chemical formula RSnX₃ is at least one selected from the group consisting of t-butyltris(dimethylamino)tin, n-butyltris(dimethylamino)tin, t-butyltris(diethylamino)tin, sec-butyltris(dimethylamino)tin, n-pentyltris(dimethylamino)tin, isobutyltris(dimethylamino)tin, isopropyltris(dimethylamino)tin, t-butyltri-t-butoxy tin, n-butyltri-t-butoxy tin, and isopropyltri-t-butoxy tin.

### Effects of the Disclosure

By the method for purifying a tin compound of the present disclosure, volatile impurities such as halogen, hydrogen halide, oxygen, and organic solvent, which cannot be removed by the conventional distillation purification, can be removed to extremely low concentrations.

### EMBODIMENTS OF THE DISCLOSURE

The present disclosure will be described hereinafter based on example embodiments of the present disclosure. However, the present disclosure is not limited to the embodiments described below.

In the present disclosure, the expression “X to Y” (X is any number and Y is any number), unless otherwise specified, means “not less than X and not greater than Y” and also includes the meaning of “preferably greater than X” or “preferably less than Y.”

Also, the expression “not less than X” (X is any number) or “not greater than Y” (Y is any number) includes the meaning of “preferably greater than X” or “preferably less than Y.”

In the present disclosure, the term “stripping” has the same meaning as defined in the chemical field, and refers to “a step of separating gas or a low-boiling point component mixed and dissolved in a liquid into a vapor phase.” Specifically, in the present disclosure, “stripping” is a step of bringing a liquid containing at least a tin compound and a volatile component, and an inert gas into gas-liquid contact, thereby separating the volatile component in the liquid into the inert gas.

The method for purifying a tin compound according to one embodiment of the present disclosure (hereinafter, may be referred to as “the present purification method”) will be described in detail hereinbelow.

The tin compound subjected to the present purification method exists as a liquid of a mixture containing at least a volatile substance. In addition to the volatile substance, the tin compound usually contains a byproduct produced in the process of synthesizing the tin compound, a solvent used for synthesizing the tin compound, and the like.

The present purification method includes: making an inert gas pass through in, or on a surface of, a liquid containing a tin compound represented by the chemical formula RSnX₃, where R represents a hydrocarbon group having 1 to 30 carbon atoms optionally substituted with a halogen atom, and X represents a hydrolysable substituent, to perform stripping, before or after a distillation step of the tin compound. When fine bubbles are not sufficiently generated, the stripping is preferably performed by applying ultrasonic vibration.

For performing the distillation and stripping of the tin compound, a purification device having the following configuration may be used, for example.

First, a distillation device of the tin compound is constituted of, for example, a distillation pot provided with a distillation column, a heater for warming the distillation pot, a cooler, and a storage tank for storing a distilled tin compound.

Next, a stripping device of the tin compound is constituted of: for example, a stripping container equipped with an ultrasonic vibrator (when ultrasonic is applied); a high purity inert gas blowing tube, which is inserted to the stripping container; a heater for warming the stripping container; a reflux condenser; and a tin compound storage tank.

A gas supply tube for pressure feeding may be provided for: performing the step of stripping before/after the distillation step in a continuous manner; delivering the distilled tin compound from the storage tank to the stripping container; delivering the tin compound from the stripping container to a raw material tank of the distillation column (a separable flask in an experimental system); and delivering the stripped tin compound from the stripping container to a storage tank for purified tin compound.

### <Tin Compound>

The present purification method is applicable to a tin compound requiring high purity, for use in applications such as a semiconductor manufacturing process.

The tin compound used in the present purification method is represented by the chemical formula RSnX₃, where R represents a hydrocarbon group having 1 to 30 carbon atoms optionally substituted with a halogen atom, and X represents a hydrolysable substituent. Hereinafter, it may be simply referred to as “the tin compound.”

In the formula, “R” represents a hydrocarbon group having 1 to 30, preferably 1 to 15, more preferably 1 to 10, and further preferably 2 to 6 carbon atoms, which are optionally substituted with a halogen atom.

Examples of the hydrocarbon group include methyl, ethyl, n-propyl, isopropyl, n-butyl, isobutyl, t-butyl, cyclopentyl, cyclohexyl, and 1-methylcyclopentyl groups.

In the formula, “X” means a hydrolysable substituent. Examples thereof include halogen, amino groups, alkoxy groups (—OR′), alkynide (R′C≡C), azide (N₃—), dialkylamino groups (—NR′₂)(—NR′R″), alkyl carbonyl amino groups (—N(R′)C(O)R′)(—N(R′)C(O)R″)(—N(R″)C(O)R′), carbonyloxy groups (—OCOR′), and carbonyl amino groups (—N(H)C(O)R′). R′ and R″ are each independent hydrocarbon groups having 1 to 10 carbon atoms. Among these, X is preferably a dialkylamino group, an alkoxy group, an alkyl carbonyl amino group, halogen, or a carbonyloxy group. In particular, X is preferably a dialkylamino group (—NR′₂) or an alkoxy group (—OR′).

The molecular weight of the tin compound is typically in the range of 200 to 900, preferably in the range of 240 to 700, and particularly preferably in the range of 280 to 500.

In the chemical formula RSnX₃ (R represents a hydrocarbon group having 1 to 30 carbon atoms optionally substituted with a halogen atom, and X represents a hydrolysable substituent), R is preferably an alkyl group having 1 to 10 carbon atoms, an alkenyl group having 1 to 10 carbon atoms, an alkynyl group having 1 to 10 carbon atoms, or an alkyl group having 1 to 10 carbon atoms substituted with a halogen atom; and X is preferably a dialkylamino group having 1 to 10 carbon atoms or an alkoxy group having 1 to 10 carbon atoms.

Specific examples of the tin compounds include t-butyltris(dimethylamino)tin, n-butyltris(dimethylamino)tin, t-butyltris(diethylamino)tin, sec-butyltris(dimethylamino)tin, n-pentyltris(dimethylamino)tin, isobutyltris(dimethylamino)tin, isopropyltris(dimethylamino)tin, t-butyltri-t-butoxytin, n-butyltri-t-butoxytin, and isopropyltri-t-butoxytin.

The tin compound may be used either alone or in combination. The method for forming a layer using the tin compound is not particularly limited, and may be selected as appropriate from various conventionally known film formation methods such as a spin coating method, a CVD method, a physical vapor deposition method, and an atomic layer deposition method.

Hereinbelow, an unpurified tin compound may be referred to as a “crude tin compound,” and a tin compound purified by the present purification method may be referred to as “the purified tin compound”, for convenience.

The crude tin compound contains, for example, a residual solvent used for synthesis; and volatile impurities such as free halogen and free hydrogen halide remaining in the process of synthesis. In addition, a metal impurity and reaction byproduct produced in the process of synthesis are contained.

Examples of the volatile impurities include water; halogen and hydrogen halide such as chlorine or hydrogen chloride; and gases such as oxygen, carbon dioxide, and butane.

Examples of the residual solvent include alcohol solvents such as methanol, ethanol, and butanol; hydrocarbon solvents such as toluene, benzene, and hexane; ether solvents such as diethyl ether and tetrahydrofuran (THF); ketone solvents such as acetone; ester solvents such as ethyl acetate; and amide solvents such as dimethylformamide (DMF) and dimethylacetamide (DMA).

Examples of the reaction byproducts include decomposition products and/or alteration products of a tin compound, such as dihydrocarbyltin compounds including a dialkylbis(dialkylamino) tin compound and a dialkyldialkoxytin compound; a tetrakis(dialkylamino) tin compound; and a tetraalkoxytin compound.

A crude tin compound typically contains, for example, at least several tens ppm of oxygen, halogen, or hydrogen halide, respectively.

### <Distillation>

In the present purification method, the crude tin compound may be distilled by any method capable of performing separation without causing decomposition or alteration of the tin compound. For example, the crude tin compound is placed in a distillation still, and then distilled, thereby a distilled tin compound is obtained. In this case, pressure distillation may cause multimerization, decomposition, or alteration of the tin compound due to high temperature operation. Thus, the distillation is preferably performed under reduced pressure or normal pressure.

Volatile impurities such as halogen, hydrogen halide, oxygen, and organic solvent in a liquid of the crude tin compound, which are difficult to be removed by distillation, can be removed in advance by performing stripping desirably prior to the distillation. Thus, it is possible to prevent production of impurities due to a side reaction in the distillation column.

Volatile impurities such as halogen, hydrogen halide, oxygen, and organic solvent in the liquid of the crude tin compound cannot be completely removed only by distillation. For example, about several tens of ppm of oxygen remain in the tin compound even after the distillation.

By heating the tin compound containing oxygen as an impurity, a reacted product of the tin compound is produced. When such a product is contained as an impurity in the vapor phase of the vaporized tin compound, a defect is caused in a growth layer of thin film in semiconductor manufacturing.

### <Stripping>

Stripping of the tin compound performed before or after the distillation step in the present purification method is to remove such volatile impurities almost completely. For example, the stripping is performed by making an inert gas such as nitrogen, argon, and helium pass through the distilled tin compound placed in the stripping container. The concentration of halogen or hydrogen halide can be reduced to not greater than 0.1 ppm, for example, by the stripping and the following distillation step. The upper limit of the concentration is typically 10 ppm. When fine bubbles are not sufficiently generated in the stripping, effect of removing the volatile impurities into gas side may be decreased. In this case, the effect can be improved by applying ultrasonic vibration.

### <Ultrasonic Vibrator>

Application of ultrasonic vibration during the stripping causes stirring by the inert gas, comminuting of the inert gas, and dispersion of the inert gas into the tin compound. Thus, removal of volatile impurities is promoted.

Ultrasonic frequency is preferably 40 kHz to 3 MHz, and particularly preferably 50 to 60 kHz. Ultrasonic output is preferably 0.1 to 240 W, and particularly preferably 0.5 to 10 W, per 1 L of the tin compound.

The shape of the stripping container is preferably such that the inert gas is efficiently contacted with the tin compound on the liquid surface of or in the liquid. Moreover, the shape is preferably such that the liquid tin compound is efficiently stirred in the container by passing of the inert gas. For more improving the stripping effect, a nozzle part for blowing the inert gas preferably has a porous structure. By such a structure, the inert gas is dispersed in fine bubbles.

Materials of the stripping container and accessory equipment such as the ultrasonic vibrator that contacts with the tin compound are not particularly limited as long as the above objects may be achieved. Typically, the materials are preferably corrosion resistant metals such as tantalum, titanium, electrolytically polished SUS 316, and electrolytically polished SUS 316L in view of corrosion resistance and for preventing degassing from the container, or purity degradation of the tin compound due to elution of impurities.

The stripping is typically performed at a room temperature (20° C.±10° C.) to 80° C., and preferably at about 40° ° C. to 50ºC for 10 minutes to 10 hours. When the ultrasonic vibration is applied, the frequency is preferably 40 kHz to 3 M Hz, and particularly preferably 50 to 60 kHz. The ultrasonic output is preferably 0.1 to 240 W, and particularly preferably 0.5 to 10 W per 1 L of the tin compound.

Examples of the inert gas introduced for the stripping includes nitrogen, helium, neon, and argon. These may be used either alone or in combination. An inert gas that has been purified to high purity is used for preventing intrusion of impurities from the inert gas itself. The concentration of impurities in the inert gas is preferably not greater than 1 ppm, more preferably not greater than 0.1 ppm, and most preferably 0 ppm.

The passing amount of the inert gas is not particularly limited, and preferably such that effect of stripping can be obtained, the liquid surface is not bumped, and no vigorous splash is caused. The passing amount is appropriately set in accordance with the size and shape of the stripping container. Typically, the amount is preferably 0.1 to 4.0 m³ (gas)/s·m³ (liquid), and more preferably 0.5 to 3.0 m³ (gas)/s·m³ (liquid) per unit volume (m³ (liquid)) of a liquid subjected to the stripping, as a volume of the inert gas (m³ (gas)) to be introduced.

When sufficient stripping conditions cannot be obtained, the stripping is preferably performed under reduced pressure condition.

On top of the stripping container, a reflux condenser is preferably provided for collecting a tin compound that accompanies the inert gas during the stripping. The reflux condenser is cooled according to the vapor pressure and melting point of the tin compound.

As described above, when the stripping is performed after the distillation, it is possible to effectively remove impurities, such as a part of a low-boiling point compound that has been separated from the tin compound in the distillation, dissolved again in the tin compound during condensation and liquefaction of the tin compound, and remains in the tin compound as it is.

The concentration of impurities in the thus obtained purified tin compound is as follows: typically not greater than 1.2 ppm, preferably not greater than 0.15 ppm, and more preferably not greater than 0.1 ppm of oxygen; not greater than 10 ppm, preferably not greater than 1.0 ppm, and more preferably not greater than 0.05 ppm of halogen or hydrogen halide; not greater than 10 ppm, preferably not greater than 5 ppm of organic solvents such as toluene; not greater than 100 ppm, preferably not greater than 10 ppm of a dihydrocarbyl tin compound; not greater than 10 ppm and preferably not greater than 1 ppm of water; and not greater than 0.1 ppm, and preferably not greater than 0.05 ppm of carbon dioxide and butane, respectively.

Because volatile impurities such as halogen, hydrogen halide, oxygen, and organic solvent are thought to cause alteration or a side reaction, they are preferably removed to extremely low concentrations.

As a method for measuring impurities in the purified tin compound, oxygen can be measured by a high sensitivity noncontact oxygen concentration meter, and general organic solvents can be measured by gas chromatography, a head space method, and the like. Examples of impurities that can be easily measured include toluene, oxygen, chlorine, or hydrogen chloride, and in particular, oxygen is preferable. Therefore, it is preferable to measure the oxygen concentration as a criterion of impurity concentration in the purified tin compound.

### EXAMPLES

Hereinafter, preferred embodiments of the present disclosure and expected values in the embodiments will be specifically described with reference to Examples. However, the present disclosure is not limited thereto.

First, a purification device used in Examples and Comparative Examples is prepared.

### <Manufacture of Purification Device for Tin Compound>

As a distillation device, a quartz-made atmospheric pressure distillation still provided with a 200 mm-length Wittmer distillation column is used. A stripping container to be used is one made of electropolished SUS 316L with an internal volume of 1 L, provided with an ultrasonic vibrator emitting 60 KHz and 1 W ultrasonic wave and a heating jacket in the outer periphery thereof, allowing for heating and heat retention. Inside the stripping container, an inert gas blowing tube (a nozzle part thereof is porous structure) for blowing a purified inert gas is inserted to the bottom. On top of the stripping container, a reflux condenser for cooling to liquefy, and refluxing a tin compound that accompanies the inert gas. In the reflux condenser, a pipe for exhaust gas is provided. A tin compound storage tank is made of electropolished SUS316L and has an internal volume of 1 L.

### Example 1

First, crude isopropyltrichlorotin is prepared as a crude tin compound. The crude isopropyltrichlorotin can be prepared by the method described in U.S. Patent Publication No. 2021/0356861, paragraphs [0147] to [0148].

The content of volatile impurities is measured using the crude isopropyltrichlorotin. In the crude isopropyltrichlorotin, the toluene concentration is about 100 ppm by gas chromatography analysis, and the oxygen concentration is about 50 ppm by a high sensitivity noncontact oxygen concentration meter.

0.5 L of the crude isopropyltrichlorotin is introduced into the stripping container from the storage tank by pressure of a purified nitrogen gas. The isopropyltrichlorotin in the stripping container is heated to 50° C., ultrasonic oscillation is started, and the purified nitrogen gas is made to pass through a liquid of isopropyltrichlorotin at a rate of 2 m³ (gas)/s·m³ (liquid) from the inert gas blowing tube. Water is made to flow through a reflux column as a coolant, and the temperature of the reflux column part is controlled to be at 25ºC.

As described above, the stripping is performed for 4 hours, and the stripping container is allowed to cool. Isopropyltrichlorotin obtained by the pressure of the purified nitrogen gas is transferred to the tin compound storage tank, thereby obtaining isopropyltrichlorotin before distillation.

The content of volatile impurities in the thus obtained isopropyltrichlorotin is measured. In the isopropyltrichlorotin before distillation, the toluene concentration is not greater than 50 ppm and the oxygen concentration is not greater than 10 ppm, by analysis of gas chromatography equipped with a photo-ionization detector.

The isopropyltrichlorotin after the stripping is distilled by the above distillation device at 50° C. and 500 Pa. The concentration of toluene and oxygen dissolved in the isopropyltrichlorotin after the distillation is about 5 ppm and about 1 ppm, respectively.

### Example 2

Crude isopropyltris(dimethylamino)tin is prepared. The content of volatile impurities is measured using the crude isopropyltris(dimethylamino)tin. In the crude isopropyltris(dimethylamino)tin, a chlorine ion concentration is about 120 ppm by analysis using combustion absorption ion chromatography, and the oxygen concentration is about 6 ppm by analysis using the high sensitivity noncontact oxygen concentration meter.

Note that the chlorine ion concentration refers to the concentration of chlorine and hydrogen chloride in which a chlorine ion is dissolved.

As in Example 1, stripping is performed by making a purified nitrogen gas pass through the crude isopropyltris(dimethylamino)tin with applying ultrasonic vibration. In the obtained isopropyltris(dimethylamino)tin, the chlorine ion concentration is not greater than 60 ppm, and the oxygen concentration is not greater than 3 ppm.

Then, isopropyltris(dimethylamino)tin after the stripping is purified as in Example 1.

In the distilled isopropyltris(dimethylamino)tin after distillation at 60° C. and 200 Pa, the concentration of dissolved chlorine ion is about 10 ppm, and the oxygen concentration is about 1 ppm.

### Comparative Example 1

Without performing stripping, crude isopropyltrichlorotin is distilled and purified as in Example 1. The concentration of toluene and oxygen dissolved in the obtained isopropyltrichlorotin is about 30 ppm and about 5 ppm, respectively.

### Comparative Example 2

Without performing stripping, isopropyltris(dimethylamino)tin is distilled and purified as in Example 2. The concentration of chlorine ion and oxygen dissolved in the obtained isopropyltris(dimethylamino)tin is about 15 ppm and about 3 ppm, respectively.

### INDUSTRIAL APPLICABILITY

By the method for purifying a tin compound of the present disclosure, a trace amount of volatile impurities dissolved in a liquid can be removed almost completely, and thus the obtained tin compound can be widely used as a material for manufacturing semiconductor devices. The tin compound obtained by the method for purifying a tin compound of the present disclosure is greatly expected as a material for manufacturing semiconductor devices that can handle a greater amount of information at a higher speed with higher precision. The present application provides a purification method for removing volatile impurities such as halogen, hydrogen halide, oxygen, and organic solvent, which cannot be removed by conventional distillation purification, to extremely low concentrations.

Obviously, numerous modifications and variations of the present invention are possible in light of the above teachings. It is therefore to be understood that within the scope of the appended claims, the invention may be practiced otherwise than as specifically described herein.

1. A method for purifying a tin compound, comprising:
making an inert gas pass through in, or on a surface of, a liquid including a tin compound of formula RSnX₃, where R is a hydrocarbon group having 1 to 30 carbon atoms optionally substituted with a halogen atom, and X is a hydrolysable substituent, to perform stripping, before or after a distillation of the tin compound.

2. The method according to claim 1, wherein the stripping is performed by applying ultrasonic vibration.

3. The method according to claim 1, wherein the inert gas is made to pass through such that the tin compound is stirred by a fine bubble of the inert gas.

4. The method according to claim 1, wherein an amount of the inert gas passing per unit volume with respect to a liquid surface of a container, in which the liquid is stored, is 0.1 to 4.0 m³ (gas)/s·m³ (liquid).

5. The method according to claim 2, wherein a frequency of the ultrasonic is 40 kHz to 3 M Hz, and an ultrasonic output is 0.1 to 240 W per 1 L of the tin compound.

6. The method according to claim 1, wherein, in the formula RSnX₃, R is an alkyl group having 1 to 10 carbon atoms, an alkenyl group having 1 to 10 carbon atoms, an alkynyl group having 1 to 10 carbon atoms, or an alkyl group having 1 to 10 carbon atoms substituted with a halogen atom, and X is a dialkylamino group having 1 to 10 carbon atoms or an alkoxy group having 1 to 10 carbon atoms.

7. The method according to claim 1, wherein the tin compound is at least one selected from the group consisting of t-butyltris(dimethylamino)tin, n-butyltris(dimethylamino)tin, t-butyltris(diethylamino)tin, sec-butyltris(dimethylamino)tin, n-pentyltris(dimethylamino)tin, isobutyltris(dimethylamino)tin, isopropyltris(dimethylamino)tin, t-butyltri-t-butoxy tin, n-butyltri-t-butoxy tin, and isopropyltri-t-butoxy tin.
